(19) United States
(12) Patent Application Publication
(10) Pub. No.: US 2007/0101153 A1
(43) Pub. Date: May 3, 2007

(54) Authentication apparatus and image forming apparatus

(75) Inventor: Seiji Kawaji, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/588,658

(22) Filed: Oct. 27, 2006

(30) Foreign Application Priority Data
Oct. 27, 2005 (JP) 2005-313233

(51) Int. Cl. H04L 9/00

(52) U.S. Cl. 713/185

(57) ABSTRACT

An authentication apparatus comprising: display means for displaying first specification information that specifies a user; and reception means for receiving second specification information different from the first specification information; wherein user authentication is performed using the first specification information displayed on the display means and the second specification information received by the reception means, the authentication apparatus being characterized by comprising: a table that sets forth a correspondence relation between identification information for identifying an external device and the first specification information; detection means for detecting presence or absence of an external device the identification information of which is stored, by means of wireless communication; means for obtaining the identification information from the external device when the presence of the above-mentioned external device is detected; means for reading, from the table, first specification information corresponding to the obtained identification information; and means for displaying the read-out first specification information.

### CROSS-REFERENCE TO RELATED APPLICATIONS

This Nonprovisional application claims priority under 35 U.S.C. §119(a) on Patent Application No. 2005-313233 filed in Japan on Oct. 27. 2005, the entire contents of which are hereby incorporated by reference.

### BACKGROUND OF THE INVENTION

1. Field of the Invention

The present invention relates to an authentication apparatus and an image forming apparatus in which a login name is inputted automatically.

2. Description of Related Art

In the prior art, a device is presently well known that logs in to a server apparatus connected to a network, thereby acquires authentication, and then performs communication with this server apparatus. The most general login procedure used at this time is that a user inputs a login name and a password imparted to a person to be authenticated, so that authentication is performed. Alternatively, without the use of a server apparatus, authentication means is provided in a device itself so that authentication is performed.

On the other hand, in the area of image forming apparatuses such as a digital combined machine, an image forming system is known that can perform wireless communication with an IC tag (see, for example, Japanese Patent Application Laid-Open No. 2000-318269 and No. 2001-22230).

In the authentication system described above, the procedure of inputting a login name and a password one by one is employed generally. Nevertheless, it is very tedious that both of the login name and the password need be inputted at each time of authentication. Thus, it has been desired that users' convenience is improved with ensuring security.

On the other hand, in the prior art image forming system that performs wireless communication with an IC tag, applications have been proposed like a printing completion reporting system and communication with an MFP-installed cartridge. Nevertheless, these approaches do not satisfy the above-mentioned desire.

### BRIEF SUMMARY OF THE INVENTION

The present invention has been devised in view of this situation. An object of the present invention is to provide an authentication apparatus and an image forming apparatus in which when an external device such as an IC tag is detected, a login name is inputted automatically so that users' convenience is improved, and in which a password is used so that security is ensured.

An authentication apparatus according to the present invention is an authentication apparatus comprising: display means for displaying first specification information that specifies a user; and reception means for receiving second specification information different from said first specification information; wherein user authentication is performed using the first specification information displayed on said display means and the second specification information received by said reception means, said authentication apparatus being characterized by comprising: a table that sets forth a correspondence relation between identification information for identifying an external device and said first specification information; detection means for detecting presence or absence of an external device the identification information of which is stored, by means of wireless communication; means for obtaining said identification information from said external device when the presence of said external device is detected; means for reading, from said table, first specification information corresponding to said obtained identification information; and means for displaying the read-out first specification information on said display means.

In this present invention, when the presence of an external device the identification information of which is stored is detected, the identification information is obtained from the external device. Then, first specification information corresponding to the obtained identification information is displayed on the display means so that convenience is improved.

An authentication apparatus according to the present invention is characterized by comprising: means for determining whether said detection means has detected the absence of said external device within a predetermined time after said first specification information is displayed; and means for bringing said first specification information displayed on said display means into a non-display state, when it is determined that the absence of said external device is detected within said predetermined time after said first specification information is displayed.

In this present invention, when the absence of an external device is detected within a predetermined time after first specification information is displayed, the first specification information displayed on the display means is brought into a non-display state so that security is improved.

An authentication apparatus according to the present invention is characterized by comprising: means for determining whether second specification information is received within a predetermined time after said first specification information is displayed; and means for bringing said first specification information displayed on said display means into a non-display state, when it is determined that the second specification information is not received within said predetermined time.

In this present invention, when second specification information is not received within a predetermined time after first specification information is displayed, the first specification information displayed on the display means is brought into a non-display state so that security is improved.

An authentication apparatus according to the present invention is characterized in that said detection means comprises: means for transmitting a predetermined signal to the outside; and means for receiving a reply signal returned in response to the transmitted signal; and detects the presence or absence of said external device based on the received reply signal.

In this present invention, a predetermined signal is transmitted to the outside. Then, based on a reply signal returned in response to the transmitted signal, the presence or absence of an external device is determined. Thus, the presence or absence of an external device is detected based on the autonomous operation of the authentication apparatus.

An authentication apparatus according to the present invention is characterized by comprising: means for determining whether a predetermined condition is satisfied, when said detection means detects the presence of said external device; and means for stopping display on said display means when it is determined that said condition is not satisfied.

In this present invention, when the presence of an external device is detected, it is determined whether a predetermined condition is satisfied. Then, when the condition is not satisfied, the display on the display means is stopped so that the situation of displaying the first specification information is restricted according to the condition.

An authentication apparatus according to the present invention is characterized in that said condition is defined concerning a receiving condition of said reply signal.

In this present invention, the receiving condition of the reply signal transmitted from the external device is defined as the condition for displaying the first specification information. Thus, the determination whether the first specification information is to be displayed is performed based on the receiving condition such as the intensity (the receiving level) of the reply signal and the continuation time length of the reply signal.

An authentication apparatus according to the present invention is characterized by further comprising means for receiving setting of said condition.

In this present invention, setting of the condition for displaying the first specification information is allowed to be received. Thus, the condition can be optimized depending on the installation condition of the authentication apparatus.

An authentication apparatus according to the present invention is characterized in that plural kinds of said correspondence relations are defined, and that priority for displaying the first specification information on said display means is defined for each of the first specification information.

In this present invention, a plurality of correspondence relations between the identification information and the first specification information are defined. Then, priority for displaying the first specification information is defined for each of the first specification information. This allows distinction between a case that the first specification information is to be displayed automatically and a case that the first specification information is not to be displayed automatically.

An authentication apparatus according to the present invention is characterized in that the first specification information is displayed in accordance with said priority when said detection means detects a plurality of external devices are detected.

In this present invention, when a plurality of external devices are detected, first specification information is displayed in accordance with the priority. Thus, even when a plurality of users each carrying an external device such as an IC card are present, one piece of first specification information is solely displayed on the display means.

An authentication apparatus according to the present invention is characterized by comprising: means for connecting an external authentication apparatus for storing a table that sets forth a correspondence relation between first specification information for specifying a user and second specification information; means for transmitting the first and the second specification information to the external authentication apparatus connected to the above-mentioned means; and means for receiving an authentication result transmitted from said external authentication apparatus, and by performing user authentication based on the received authentication result.

In this present invention, the first specification information for specifying a user and the second specification information are transmitted to the external authentication apparatus so that user authentication is performed.

An authentication apparatus according to the present invention is characterized by comprising: a table that sets forth a correspondence relation between first specification information for specifying a user and second specification information; and means for determining whether when second specification information is received by said reception means, first specification information corresponding to the received second specification information is stored in said table; and by performing user authentication based on the determination result obtained by the above-mentioned means.

In this present invention, the table that sets forth a correspondence relation between the first specification information for specifying a user and the second specification information is provided so that user authentication is performed with reference to the table.

An authentication apparatus according to the present invention is characterized in that said table is encrypted and that when said table is to be referred to, means for decrypting the encrypted table and volatile storage means for storing the decrypted table are used.

In this present invention, the table is stored in an encrypted manner. Then, when the table is to be referred to, the encrypted table is decrypted, and then the decrypted table is stored in the volatile storage means. This improves security.

An authentication apparatus according to the present invention is characterized by comprising: means for receiving image data; means for forming an image on a sheet based on the received image data; and an authentication apparatus according to any one of the above-mentioned inventions; and in that said authentication apparatus performs user authentication when the image data is received.

In this present invention, the means for receiving image data and the means for forming an image on a sheet based on the received image data are provided so that when image data is received, user authentication is performed. Thus, the use of the apparatus is allowed only for authorized users.

According to the present invention, when the presence of an external device the identification information of which is stored is detected, the identification information is obtained from the external device. Then, first specification information corresponding to the obtained identification information is displayed on the display means. Thus, even when user authentication is performed using the first specification information indicating a login name and the second specification information indicating a password, the user oneself need not input both. This improves convenience. Further, even when the first specification information is displayed, the second specification information is inputted by the user oneself This ensures security.

According to the present invention, when the absence of an external device is detected within a predetermined time after first specification information is displayed, the first specification information displayed on the display means is brought into a non-display state. Thus, when it is determined that the user has left the place, the first specification information can be brought into a non-display state. Thus, the possibility is reduced that the first specification information assigned to a specific user could be known to unspecified persons. This improves security.

According to the present invention, when second specification information is not received within a predetermined time after first specification information is displayed, the first specification information displayed on the display means is brought-into a non-display state. Thus, when it is determined that the user does not intend to use the apparatus, the first specification information can be brought into a non-display state. Thus, the possibility is reduced that the first specification information assigned to a specific user could be known to unspecified persons. This improves security.

According to the present invention, a predetermined signal is transmitted to the outside. Then, based on a reply signal returned in response to the transmitted signal,.the presence or absence of an external device is determined. Thus, the presence or absence of an external device can be detected based on the autonomous operation of the authentication apparatus. Detection techniques employable for this purpose include: wireless communication using an IC tag; Bluetooth; and infrared communication.

According to the present invention, when the presence of an external device is detected, it is determined whether a predetermined condition is satisfied. Then, when the condition is not satisfied, the display on the display means is stopped. This permits setting of a condition for restricting the displaying of the first specification information.

According to the present invention, the receiving condition of a reply signal transmitted from the external device is defined as the condition for displaying the first specification information. Thus, the determination whether the first specification information is to be displayed is performed based on the receiving condition such as the receiving level and the continuation time length of the reply signal.

According to the present invention, setting of the condition for displaying the first specification information is allowed to be received. Thus, the condition can be optimized depending on the installation condition of the authentication apparatus.

According to the present invention, a plurality of correspondence relations between the identification information and the first specification information are defined. Then, priority for displaying the first specification information is defined for each of the first specification information. This allows distinction between a case that the first specification information is to be displayed automatically and a case that the first specification information is not to be displayed automatically.

According to the present invention, when a plurality of external devices are detected, first specification information is displayed in accordance with the priority. Thus, even when a plurality of users each carrying an external device such as an IC card are present, one piece of first specification information is solely displayed in accordance with the priority rule.

According to the present invention, first specification information for specifying a user and second specification information are transmitted to the external authentication apparatus so that user authentication is performed. Thus, the first and the second specification information can be managed by a single apparatus.

According to the present invention, a table is provided that sets forth a correspondence relation between the first specification information for specifying a user and the second specification information. Then, user authentication is performed with reference to the table. This permits user authentication even in the case of absence of the function of connection to a communication network.

According to the present invention, the table is stored in an encrypted manner. Then, when the table is to be referred to, the encrypted table is decrypted, and then the decrypted table is stored in the volatile storage means. This improves security.

According to the present invention, the means for receiving image data and the means for forming an image on a sheet based on the received image data are provided so that when image data is received, user authentication is performed. Thus, the use of the apparatus is allowed only for authorized users.

The above and further objects and features of the invention will more fully be apparent from the following detailed description with accompanying drawings.

### BRIEF DESCRIPTION OF THE SEVERAL VIEWS OF THE DRAWINGS

FIG. 1A and 1B are schematic diagrams describing an operation of a digital combined machine according to an embodiment of the present invention;

FIG. 2 is a block diagram describing a configuration of an authentication system employing a digital combined machine;

FIG. 3 is a conceptual diagram showing an example of a user management table;

FIG. 4 is a schematic diagram showing an example of an operation panel;

FIG. 5 is a conceptual diagram showing an example of an authentication table;

FIG. 6 is a flow chart describing a procedure of processing performed by a digital combined machine;

FIG. 7 is a flow chart describing a procedure of processing performed by a digital combined machine;

FIG. 8 is a conceptual diagram showing a table that sets forth a receiving level and a continuation time length;

FIG. 9 is a conceptual diagram showing an example of a user management table that sets forth priority of login names to be displayed;

FIG. 10 is a flow chart describing a procedure of processing performed by a digital combined machine;

FIG. 11 is a flow chart describing a procedure of processing performed by a digital combined machine;

FIG. 12 is a block diagram describing a configuration of an authentication system according to an embodiment of the present invention;

FIG. 13 is a conceptual diagram showing an example of an authentication table; and

FIG. 14 is a flow chart describing an operation of a digital combined machine at the time of power on.

### DETAILED DESCRIPTION OF THE INVENTION

A mode in which an image forming apparatus according to the present invention is applied to a digital combined machine is described below in detail with reference to the drawings.

### Embodiment 1

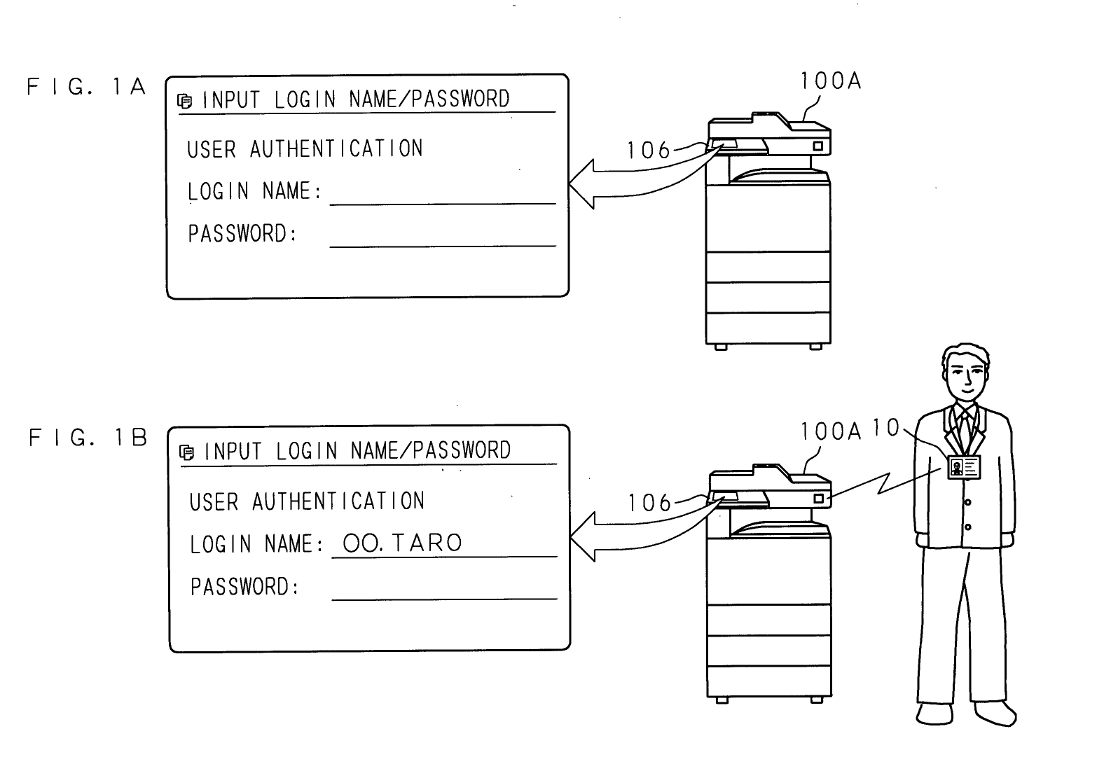

FIG. 1A is a schematic diagram describing an operation of a digital combined machine according to an embodiment of the present invention. In the figure, numeral 100A indicates a digital combined machine having: a scanner function of optically reading an image of a manuscript; a copy function of forming an image onto a sheet such as a paper sheet and an OHP film based on the image data read and obtained from the manuscript; an image transmission function of transmitting the image data read and obtained from the manuscript, to the outside via a communication network; and a printer function of receiving a print job transmitted from the outside and then performing image formation. In the present embodiment, user authentication is performed for the functions such as such as the scanner function, the copy function, and the image transmission function where the digital combined machine 100A is operated directly. Then, only when the user authentication has been successful, the use of these functions is allowed.

In the user authentication, a login name assigned to each user and a password set up by each user are used. From the perspective of users' convenience, the login name is inputted automatically, while from the perspective of security, the password is manually inputted by a user oneself. For the purpose of the automatic input of the login name, an IC card 10 is used in which an IC chip is embedded. When a user carrying an IC card 10 is present near the digital combined machine 100A, based on information obtained from the IC card 10, a login name assigned to the user is extracted so that the extracted login name is displayed on an operation panel 106 (see FIG. 1B). In contrast, when a user carrying an IC card 10 is not present near the digital combined machine 100A, no user name is displayed (see FIG. 1A). In the state that a login name is displayed, when the user inputs merely the password, user authentication is performed so that convenience is improved. Further, since the password need be inputted by the user oneself, security degradation is avoided.

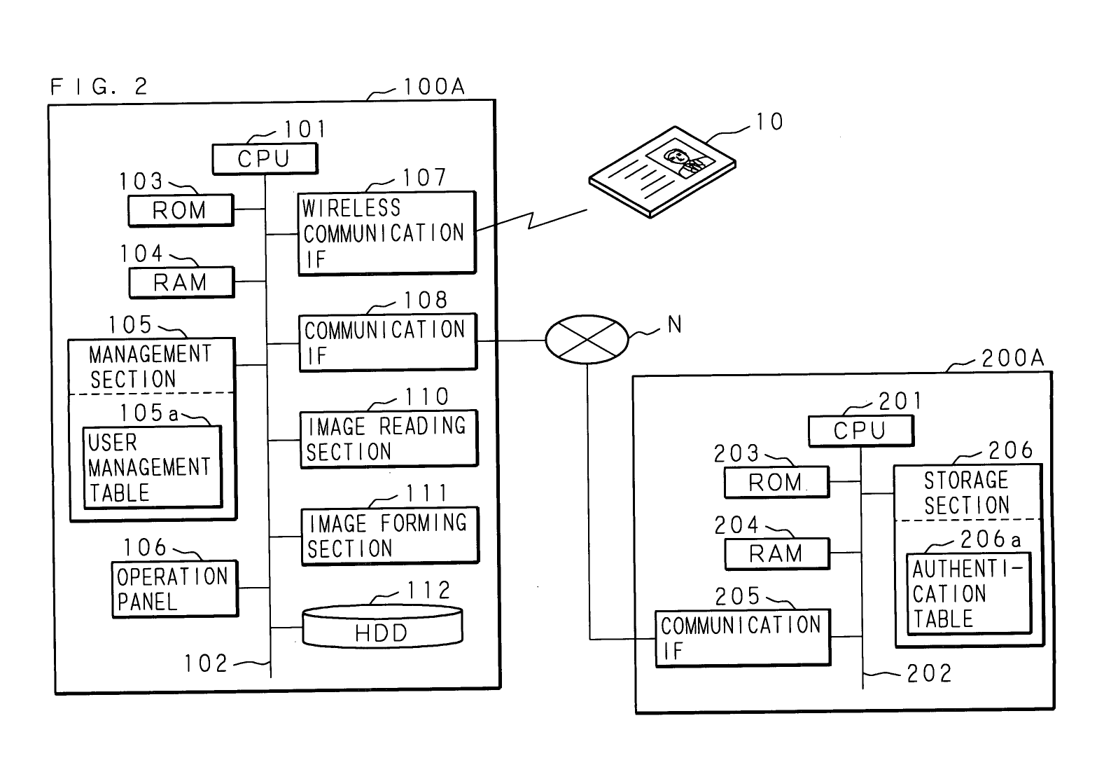

FIG. 2 is a block diagram describing a configuration of an authentication system employing the digital combined machine 100A. The digital combined machine 100A has a CPU 101. The CPU 101 reads and executes a control program stored in advance in a ROM 103, thereby controls various kinds of hardware connected via a bus 102, and thereby causes the entire apparatus to serve as an authentication apparatus and an image forming apparatus according to the present invention.

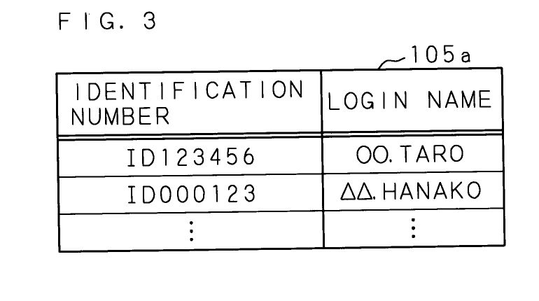

A management section 105 is composed of a nonvolatile semiconductor memory. A part of the storage area is used as a user management table 105a. FIG. 3 is a conceptual diagram showing an example of the user management table 105a. In the user management table 105a, identification numbers each for identifying an IC card (e.g., an IC card 10) and login names each for specifying a user are stored in a manner corresponding to each other. Each identification number is identification information for identifying an IC card, and may be composed of a numerical value having an appropriate number of digits or alternatively a combination of alphabetical characters, numeric characters, and the like. Each login name is used as first specification information for specifying a user, and is defined uniquely for each user by a manager of the present system or by the user oneself.

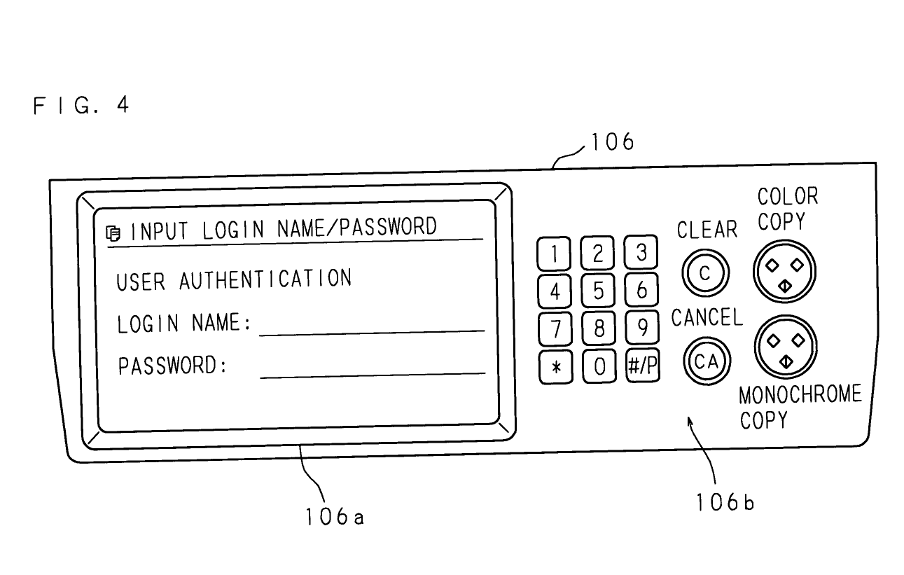

The operation panel 106 receives an operation instruction from a user, and displays information to be reported to a user. FIG. 4 is a schematic diagram showing an example of the operation panel 106. The operation panel 106 includes: a display section 106a for displaying information to be reported to a user; and an operation section 106b for receiving an operation instruction from a user. The display section 106a includes, for example, a liquid crystal display unit and thereby displays information such as an operation guide to a user, a setting value received through the operation section 106b, and an error message. The operation section 106b includes a plurality of hardware keys. The hardware keys provided in the operation section 106b include: a numerical keypad used for numerical input; a clear key for clearing an inputted setting value; an end key for terminating various kinds of setting; a color copy key for issuing a start instruction for color copy; and a monochrome copy key for issuing a start instruction for monochrome copy. Here, a touch panel may be provided on the display section 106a so that a selection operation may be received in correspondence to a displayed operation guide.

A wireless communication IF 107 is an interface for performing wireless communication with the IC card 10. The IC card 10 includes in the inside: an antenna circuit fabricated by printing a conductor pattern on an insulating substrate; and an IC chip connected to the antenna circuit. In the IC card 10, electric power is supplied to the antenna circuit from a signal transmitted from the wireless communication IF 107. The IC chip supplied with the electric power through the antenna circuit generates a reply signal based on data of the identification number stored in advance in an internal memory in the chip, and then transmits the generated reply signal to the outside through the antenna circuit. On the other hand, the wireless communication IF 107 includes: a signal generating circuit for generating a signal to be transmitted to the IC card 10; an antenna circuit for transmitting the generated signal to the outside and receiving a reply signal from the IC card 10; and a receiving circuit for extracting the identification number of the IC card 10 from the reply signal received through the antenna circuit. When receiving a reply signal from the IC card 10, the wireless communication IF 107 extracts the identification number of the IC card 10 from the reply signal, and then notifies the identification number to the CPU 101.

A communication IF 108 is an interface for connection to a communication network N such as a local area network and the Internet network. An authentication server 200A is connected to this communication network N so that the digital combined machine 100A can transmit and receive various kinds of information to and from the authentication server 200A via the communication IF 108. Information transmitted from the digital combined machine 100A to the authentication server 200A includes: a login name corresponding to identification information (first specification information) obtained by the wireless communication IF 107; and a password (second specification information) received through the operation panel 106. Further, information received by the digital combined machine 100A from the authentication server 200A is information concerning an authentication result indicating whether a user has successfully been authenticated based on the transmitted login name and password.

An image reading section 110 includes (not shown): a light source for projecting light onto a manuscript to be read; an image sensor such as a CCD (Charge Coupled Device); and an AD converter. An image of a manuscript located at a predetermined reading position is formed on the image sensor so that the image is converted into an analog electric signal. Then, the obtained analog signal is AD-converted by the AD converter. After that, correction is performed on the digital signal obtained by AD conversion, with taking into consideration the orientation property of the light source at the time of manuscript reading, sensitivity inhomogeneity of the image sensor, and the like, so that image data of digital format is generated.

An image formation section 111 includes, for example (not shown): an electrostatic charger for electrostaically charging a photosensitive drum at a predetermined potential; a laser writing unit for emitting laser light according to image data received from the outside and thereby generating an electrostatic latent image on the photosensitive drum; a developing unit for supplying toner to the electrostatic latent image formed on the photosensitive drum surface and thereby causing the latent image to be visible; and a transfer unit for transferring the toner image formed on the photosensitive drum surface onto a paper sheet. Thus, the image formation section 111 records an image desired by a user onto a paper sheet by electrophotography.

Here, in the present embodiment, image formation is performed by electrophotography using a laser writing unit. Instead, the image formation may be performed by an inkjet method, a heat transfer method, or a sublimation method.

An HDD 112 has a magnetic recording medium and can accumulate image data processed internally. The accumulated image data is read out, for example, when an instruction is issued through the operation panel 106. Thus, when printing processing need be re-executed because of a failure in the printing processing, an insufficient number of outputted copies, or the like, the accumulated image data can be read out so that the printing processing can be executed.

The internal configuration of the authentication server 200A is described below. The authentication server 200A has a CPU 201. This CPU 201 is connected via a bus 202 to hardware including a ROM 203, a RAM 204, a communication IF 205, and a storage section 206. The CPU 201 uploads onto the RAM 204 a control program stored in advance in the ROM 203, then executes the program, and thereby controls the operation of the entire apparatus so as to perform user authentication.

The communication IF 205 is an interface for connection to the communication network N, and allows various kinds of information to be transmitted to and received from the digital combined machine 100A. Information received by the authentication server 200A via the communication IF 205 is a login name (first specification information) and a password (second specification information) transmitted from the digital combined machine 100A. Further, information transmitted by the authentication server 200A via the communication IF 205 is information concerning the result of user authentication performed based on the received login name and password.

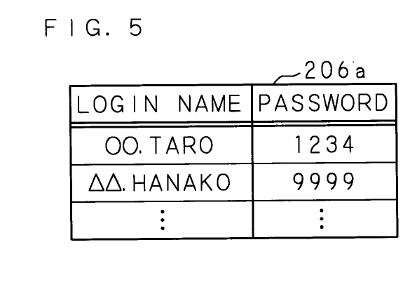

The storage section 206 includes an HDD device or a nonvolatile semiconductor memory. A part of the storage area of the storage section 206 is used as an authentication table 206a. FIG. 5 is a conceptual diagram showing an example of the authentication table 206a. The authentication table 206a sets forth a correspondence relation between each login name serving as the first specification information and each password serving the second specification information. As described above, each login name is information defined uniquely for each user by a manager of the present system or by each user oneself. Each password is information set up by each user oneself, and may be composed of a numerical value having an appropriate number of digits or alternatively a combination of alphabetical characters, numeric characters, and the like.

When receiving a login name and a password through the communication IF 205, the authentication server 200A refers to the authentication table 206a in the storage section 206 and thereby performs user authentication. That is, the CPU 201 of the authentication server 200A searches the authentication table 206a and thereby determines whether the received login name is registered in the authentication table 206a. When the login name is registered in the authentication table 206a, the CPU 201 refers to the authentication table 206a and thereby determines whether the received login name and password is an authorized combination. When it is determined as an authorized combination, successful authentication of the user is reported. In contrast, when it is determined that the received login name is not registered in the authentication table 206a, or alternatively when it is determined that the combination of the received login name and password is not an authorized combination, unsuccessful authentication of the user is reported.

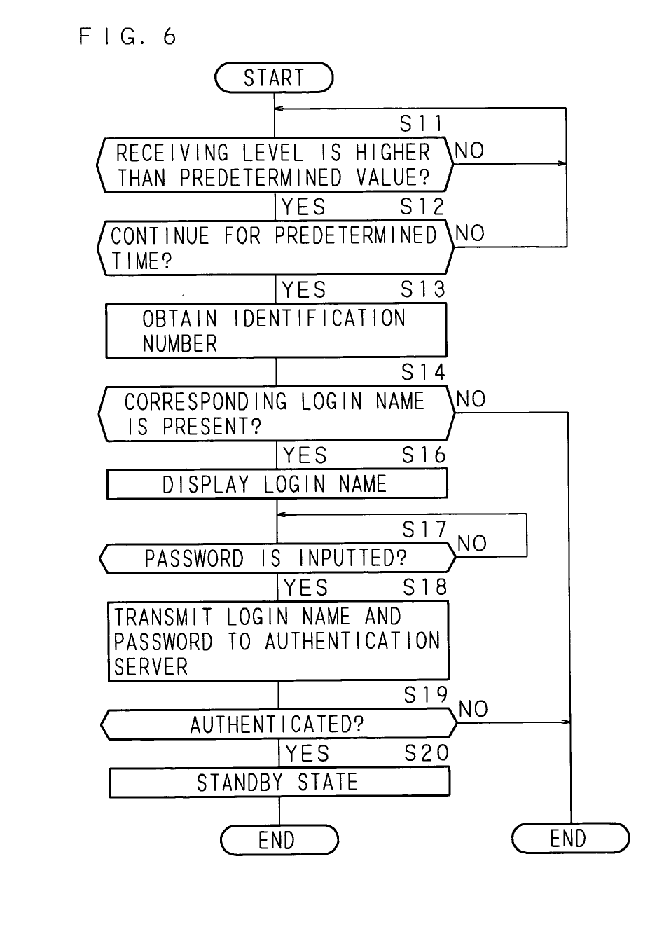

The procedure of processing performed by the digital combined machine 100A is described below. FIG. 6 is a flow chart describing a procedure of processing performed by the digital combined machine 100A. First, the CPU 101 of the digital combined machine 100A determines whether the wireless communication IF 107 has received a signal having a receiving level of a predetermined value or higher (step S11). When it is determined that a signal having a receiving level of the predetermined value or higher is not received (S11: NO), the CPU 101 waits until a signal having a receiving level of the predetermined value or higher is received.

When it is determined that the wireless communication IF 107 has received a signal having a receiving level of the predetermined value or higher (S11: YES), the CPU 101 determines whether the receiving of the signal has continued for a predetermined time (step S12). When it is determined that the receiving of the signal has not continued for the predetermined time (S12: NO), the CPU 101 returns the processing to step S11.

When the receiving of the signal having a receiving level of the predetermined value or higher has continued for the predetermined time (S12: YES), the wireless communication IF 107 obtains from the signal the identification number for identifying the IC card 10 (step S13). The obtained identification number is notified to the CPU 101.

When receiving the identification number, the CPU 101 refers to the user management table 105a in the management section 105, and thereby determines whether a corresponding login name is present (step S14). When it is determined that a corresponding login name is not present (S14: NO), the CPU 101 terminates the processing in the present flow chart. At that time, a screen for receiving the input of a login name and a password is displayed on the display section 106a of the operation panel 106. Thus, the user can manually input the login name and the password by a method of operating the operation panel 106.

When it is determined that a corresponding login name is present (S14: YES), the CPU 101 reads a login name corresponding to the identification number of the IC card 10 from the user management table 105a, and then displays the login name on the display section 106a of the operation panel 106 (step S16). After displaying the login name on the display section 106a, the CPU 101 determines whether a password has been inputted through the operation panel 106 (step S17). When a password is not yet inputted (S17: NO), the CPU 101 waits until a password is inputted.

When it is determined that a password has been inputted through the operation panel 106 (S17: YES), a login name read from the user management table 105a based on the identification number of the IC card 10 and the password inputted through the operation panel 106 are transmitted to the authentication server 200A via the communication network N (step S18).

After transmitting the login name and the password, the CPU 101 determines the successfulness or unsuccessfulness of the authentication of the user based on an authentication result transmitted from the authentication server 200A (step S19). When the authentication of the user is determined as unsuccessful (S19: NO), the CPU 101 terminates the processing in the present flow chart. At that time, the screen for receiving the input of a login name and a password may be re-displayed on the display section 106a so that a login name and a password may be received by means of an input operation through the operation panel 106. On the other hand, when the authentication of the user is determined as successful (S19: YES), the CPU 101 goes into a standby state where the use of the original functions such as a scanner function and a copy function of the digital combined machine 100A is permitted (step S20).

Here, in the present embodiment, user authentication has been performed when the original functions such as a scanner function and a copy function are to be used. Instead, user authentication may be performed only when a particular function is to be used.

### Embodiment 2

In Embodiment 1, after the login name has been displayed on the display section 106a on the operation panel 106, password input has been waited. Instead, after the displaying of the login name, when a signal in a predetermined receiving condition is not received from the IC card 10, that is, when the user carrying an IC card 10 is determined as having left the vicinity of the digital combined machine 100A, the login name displayed on the display section 106a may be brought into a non-display state.

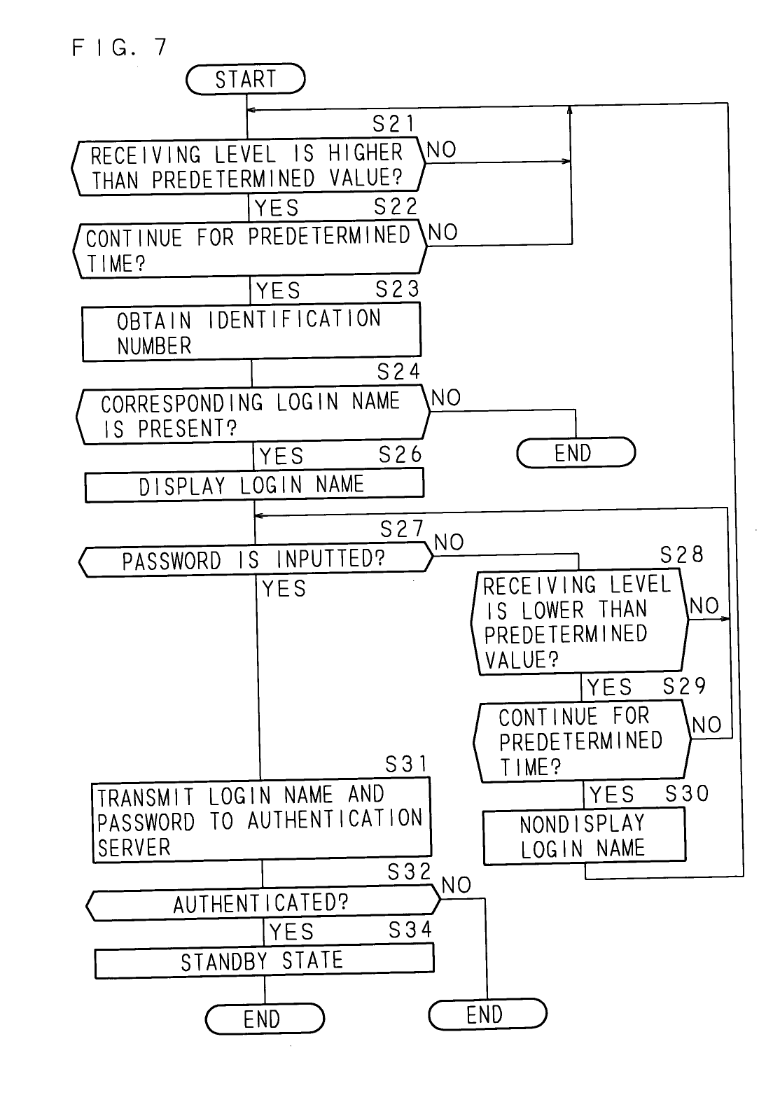

FIG. 7 is a flow chart describing a procedure of processing performed by the digital combined machine 100A. The digital combined machine 100A performs the processing from step S21 to step S26 in the same manner as Embodiment 1. That is, when a signal is received from an IC card having an identification number registered in the user management table 105a, a login name corresponding to the identification number is read from the user management table 105a. Then, the read-out login name is displayed on the display section 106a.

Then, the CPU 101 determines whether a password has been inputted through the operation panel 106 (step S27). When a password is not yet inputted (S27: NO), the CPU 101 determines whether a signal received through the wireless communication IF 107 has a receiving level of a predetermined value or lower (step S28). When it is determined that the receiving level is higher than the predetermined value (S28: NO), the CPU 101 returns the processing to step S27. Further, when it is determined that the receiving level is at or below the predetermined value (S28: YES), the CPU 101 determines whether that state has continued for a predetermined time (step S29). When it is determined that the state has not continued for the predetermined time (S29: NO), the CPU 101 returns the processing to step S27. When the state that the receiving level is at or below the predetermined value has continued for the predetermined time (S29: YES), the CPU 101 brings into a non-display state the login name displayed on the display section 106a (step S30), and then returns the processing to step S21.

When it is determined that a password has been inputted at step S27 (S27: YES), a login name read from the user management table 105a based on the identification number of the IC card and the password inputted through the operation panel 106 are transmitted to the authentication server 200A via the communication network N (step S31).

After transmitting the login name and the password, the CPU 101 determines the successfulness or unsuccessfulness of the authentication of the user based on an authentication result transmitted from the authentication server 200A (step S32). When the authentication of the user is determined as unsuccessful (S32: NO), the CPU 101 terminates the processing in the present flow chart. At that time, the screen for receiving the input of a login name and a password may be re-displayed on the display section 106a so that a login name and a password may be received by means of an input operation through the operation panel 106. On the other hand, when the authentication of the user is determined as successful (S32: YES), the CPU 101 goes into a standby state where the use of the original functions such as a scanner function and a copy function of the digital combined machine 100A is permitted (step S34).

As such, in the present embodiment, when a login name is displayed on the display section 106a, the receiving condition of the signal received by the wireless communication IF 107 is checked so that when it is determined that the user carrying the IC card has left the vicinity of the digital combined machine 100A, displaying of the login name is stopped. This avoids that the user name is left in a displayed state, and hence improves security.

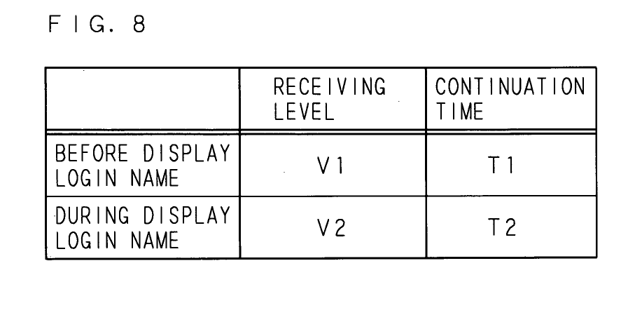

Further, as for the threshold values for the receiving level and the continuation time length which are set up for the check of the receiving condition of the wireless communication IF 107, the values before the display of the login name may differ from those during the display of the login name. For example, the table shown in the conceptual diagram of FIG. 8 may be held in the management section 105 so that adopted threshold values may be changed depending on the situation whether the login name is displayed or not. Further, these threshold values may be set up depending on the installation condition of the individual digital combined machine 100A. In this case, a threshold value for the receiving level and a threshold value for the continuation time length may be received through the operation panel 106 so that the table shown in FIG. 8 may be updated.

Further in the present embodiment, when the login name has been displayed on the display section 106a, the receiving condition of the signal received by the wireless communication IF 107 has been checked so that when the user carrying an IC card 10 has been determined as having left the vicinity of the digital combined machine 100A, the displaying of the login name has been stopped. Instead, the displaying of the login name may be stopped when a password is not inputted within a predetermined time after the login name is displayed. In this case, at the time that the login name is displayed, time counting is started in a built-in timer of the CPU 101. Then, when a predetermined time has elapsed in a state that no password is inputted, the login name displayed on the display section 106a may be brought into a non-display state.

### Embodiment 3

In the embodiments described above, when an identification number of the IC card has been obtained, in the case that a login name corresponding to the identification number has been registered in the user management table 105a, the login name has been displayed on the display section 106a on the operation panel 106. Instead, priority may be set up in order that a user whose login name is to be displayed automatically should be distinguished from a user whose login name is not to be displayed automatically.

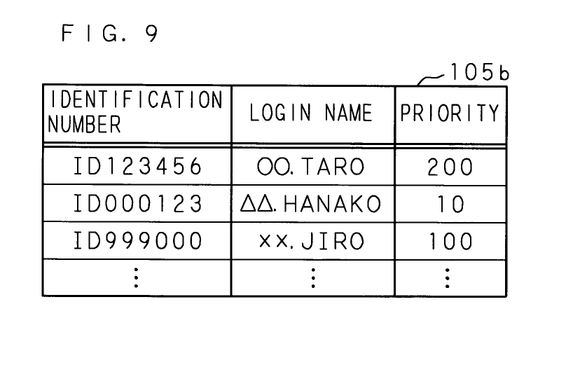

FIG. 9 is a conceptual diagram showing an example of a user management table that sets forth priority of login names to be displayed. In the present embodiment, in place of the user management table 105a, a user management table 105b that sets forth a correspondence relation between the identification number, the login name, and the priority as shown in FIG. 9 is stored in the management section 105. The priority is defined as a numerical value. A higher priority is assigned to a greater numerical value.

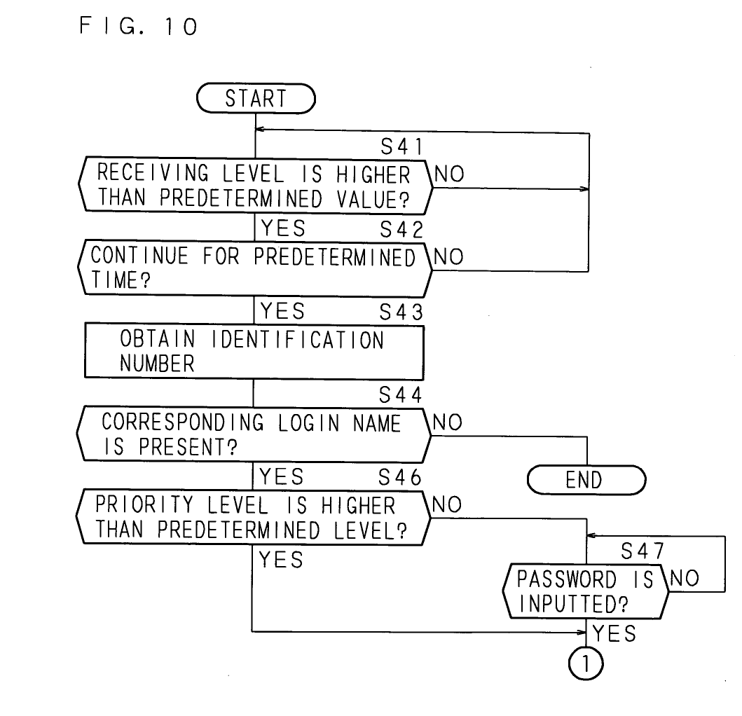

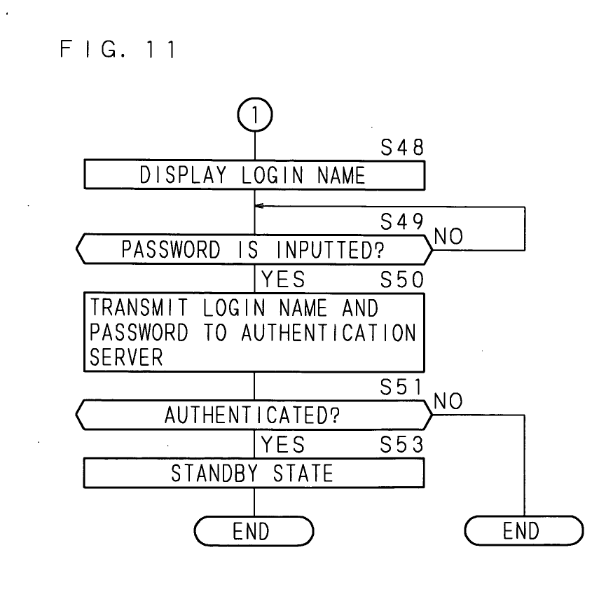

FIGS. 10 and 11 are flow charts describing a procedure of processing performed by the digital combined machine 100A. The digital combined machine 100A performs the processing from step S41 to step S43 in the same manner as Embodiment 1. That is, the digital combined machine 100A receives a signal transmitted from an IC card, and then obtains the identification number.

When the identification number is obtained, it is determined whether a login name corresponding to the identification number is present in the user management table 105b (step S44). When it is determined that a login name corresponding to the identification number is not present (S44: NO), the CPU 101 terminates the processing in the present flow chart. At that time, a screen for receiving the input of a login name and a password is displayed on the display section 106a of the operation panel 106. Thus, the user can manually input the login name and the password by a method of operating the operation panel 106.

When it is determined that a login name corresponding to the identification number is present (S44: YES), the CPU 101 determines whether the priority set up to the login name is higher than a predetermined priority level (step S46). In the present embodiment, when the priority is higher than the predetermined priority level, the login name is automatically displayed on the display section 106a. When the priority is lower than the predetermined priority level, a login name is inputted manually. Thus, at step S46, when it is determined that the priority is lower than the predetermined priority level (S46: NO), the CPU 101 determines whether a login name has been inputted through the operation panel 106 (step S47). When it is determined that a login name is not inputted (S47: NO), the CPU 101 waits until a login name is inputted.

When it is determined at step S47 that a login name has been inputted (S47: YES), or alternatively when it is determined at step S46 that the priority is higher than the predetermined priority level (S46: YES), the CPU 101 displays the login name on the display section 106a (step S48). For example, when the predetermined priority level is set at 150, “OO TARO” is solely displayed automatically among the login names shown in FIG. 9. The other login names “ΔΔ HANAKO” and “×× JIRO” are displayed when each login name is inputted manually by the user.

After displaying the login name on the display section 106a, the CPU 101 determines whether a password has been inputted through the operation panel 106 (step S49). When a password is not yet inputted (S49: NO), the CPU 101 waits until a password is inputted. When it is determined that a password has been inputted through the operation panel 106 (S49: YES), a login name read from the user management table 105a based on the identification number of the IC card 10 and the password inputted through the operation panel 106 are transmitted to the authentication server 200A via the communication network N (step S50).

After transmitting the login name and the password, the CPU 101 determines the successfulness or unsuccessfulness of the authentication of the user based on an authentication result transmitted from the authentication server 200A (step S51). When the authentication of the user is determined as unsuccessful (S51: NO), the CPU 101 terminates the processing in the present flow chart. At that time, the screen for receiving the input of a login name and a password may be re-displayed on the display section 106a so that a login name and a password may be received by means of an input operation through the operation panel 106. On the other hand, when the authentication of the user is determined as successful (S51: YES), the CPU 101 goes into a standby state where the use of the original functions such as a scanner function and a copy function of the digital combined machine 100A is permitted (step S53).

### Embodiment 4

In the embodiments described above, the digital combined machine 100A has managed the user management table 105a, while the authentication server 200A has managed the authentication table 206a. Instead, both tables may be managed in an encrypted state in the server, and then may be downloaded at the time of power on of the digital combined machine.

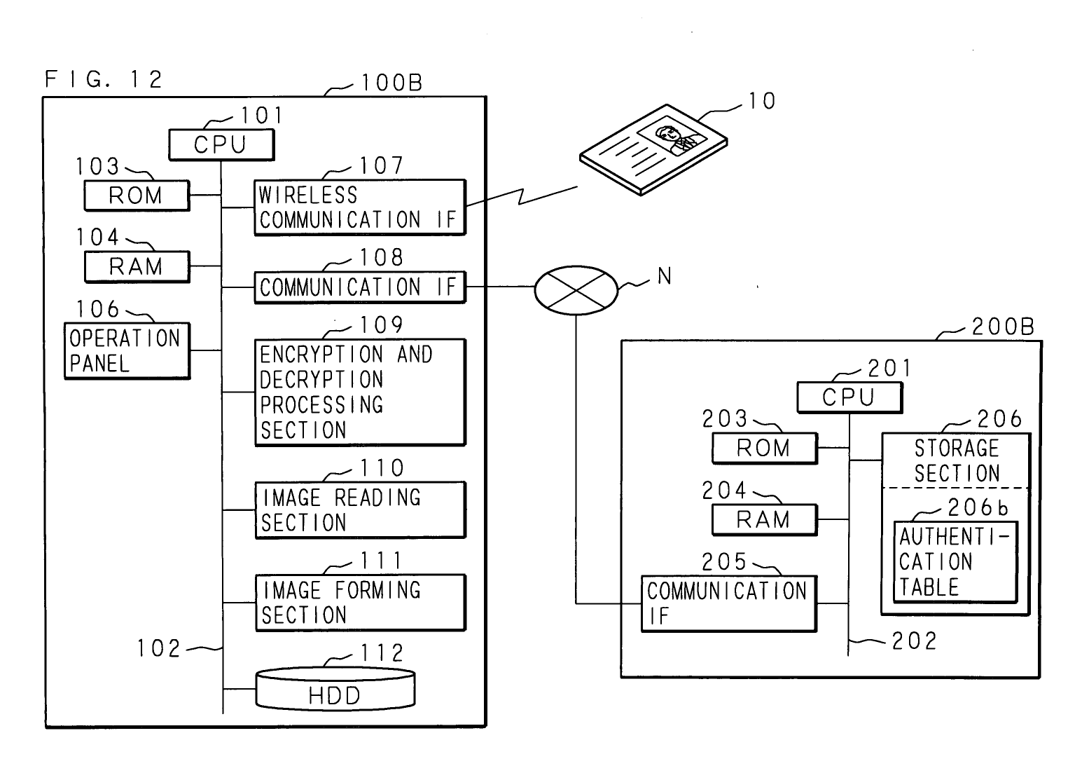

FIG. 12 is a block diagram describing a configuration of an authentication system according to an embodiment. A digital combined machine 100B has a CPU 101. The CPU 101 is connected via a bus 102 to hardware including a ROM 103, a RAM 104, an operation panel 106, a wireless communication IF 107, a communication IF 108, an encryption and decryption processing section 109, an image reading section 110, an image formation section 111, and an HDD 112. Here, the hardware configuration other than the encryption and decryption processing section 109 is the same as that of Embodiment 1, and hence the description is omitted.

The encryption and decryption processing section 109 performs encryption and decryption of electronic data. Electronic data to be decrypted in the encryption and decryption processing section 109 is an authentication table 206b transmitted from the authentication server 200B described later. Electronic data to be encrypted is data in which new contents of registration is added in order to update the authentication table 206b. For the purpose of encryption and decryption of the electronic data, the encryption and decryption processing section 109 includes: an input buffer for temporarily holding target data; an arithmetic circuit for performing an arithmetic operation according to predetermined decryption algorithm or encryption algorithm on the data held in the input buffer; and an output buffer for holding the arithmetic operation result obtained by the arithmetic circuit. The CPU 101 extracts the arithmetic operation result from the output buffer, and thereby obtains decrypted data or encrypted data.

The authentication server 200B is described below. The authentication server 200B has a CPU 201. This CPU 201 is connected via a bus 202 to a ROM 203, a RAM 204, a communication IF 205, and a storage section 206 that stores the authentication table 206b.

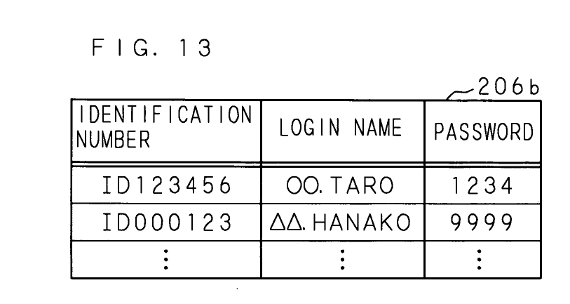

FIG. 13 is a conceptual diagram showing an example of the authentication table 206b. In the present embodiment, the identification number for identifying an IC card, the login name serving as the first specification information for specifying a user, and the password serving as the second specification information are managed collectively in the authentication table 206b. This authentication table 206b is stored in an encrypted state in the storage section 206. When a transmission request is issued from the digital combined machine 100B, the CPU 201 of the authentication server 200B reads the encrypted authentication table 206b from the storage section 206, and then transmits the read-out authentication table 206b to the digital combined machine 100B.

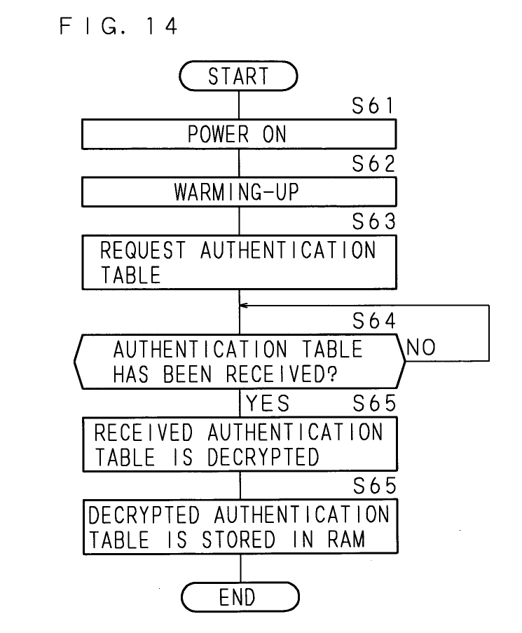

FIG. 14 is a flow chart describing an operation of the digital combined machine 100B at the time of power on. When the digital combined machine 100B is turned on the power(step S61), warming-up is performed (step S62), so that a state ready for receiving data is established in each hardware section. After the warming-up, the CPU 101 requests the authentication server 200B for the authentication table 206b (step S63). Specifically, an instruction that indicates that the authentication table 206b should be transmitted is transmitted to the authentication server 200B via the communication network N.

After requesting the authentication table 206b, the CPU 101 determines whether the authentication table 206b has been received (step S64). When it is determined that the authentication table 206b is not yet received (S64: NO), the CPU 101 waits until the authentication table 206b is received. When it is determined that the authentication table 206b has been received (S64: YES), the received authentication table 206b is decrypted by the encryption and decryption processing section 109 (step S65). Then, the decrypted authentication table 206b is stored in the RAM 104 (step S66).

The authentication table 206b stored in the RAM 104 sets forth a correspondence relation between the identification number and the login name and a relation between the login name and the password. Thus, when the identification number of an IC card is obtained, a login name corresponding to the identification number can be read and then displayed on the display section 106a on the operation panel 106. Then, when a password is inputted through the operation panel 106, the processing (authenticating processing) of determining whether the password is an authorized password can be performed.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An authentication apparatus comprising:
a display section for displaying first specification information that specifies a user;
a reception section for receiving second specification information different from said first specification information;
a storage section for storing identification information that identifies an external device and said first specification information in a manner corresponding to each other;
a wireless communication section for performing wireless communication with an external device; and
a controller capable of performing operations of:
detecting presence or absence of an external device the identification information of which is stored in said storage section, based on information obtained by said wireless communication section;
obtaining the identification information from the external device when the presence of said external device is detected;
reading first specification information, which is corresponding to the obtained identification information, from said storage section;
displaying the read-out first specification information on said display section; and
performing user authentication based on the first specification information displayed on said display section and the second specification information received by said reception section.

2. The authentication apparatus according to claim 1, wherein said controller is further capable of performing operations of determining whether the absence of said external device is detected within a predetermined time after said first specification information is displayed; and
bringing said first specification information displayed on said display section into a non-display state, when it is determined that the absence of said external device is detected within said predetermined time after said first specification information is displayed.

3. The authentication apparatus according to claim 1, wherein said controller is further capable of performing operations of determining whether second specification information is received within a predetermined time after said first specification information is displayed; and
bringing said first specification information displayed on said display section into a non-display state, when it is determined that the second specification information is not received within said predetermined time.

4. The authentication apparatus according to claim 1, further comprising: a transmission section for transmitting a predetermined signal to the outside; and
a receiving section for receiving a reply signal returned in response to the transmitted signal; wherein
said controller is further capable of detecting the presence or absence of said external device based on the received reply signal.

5. The authentication apparatus according to claim 1, wherein said controller is further capable of performing operations of: determining whether a predetermined condition is satisfied, when the presence of said external device is detected; and
stopping display on said display section when it is determined that said condition is not satisfied.

6. The authentication apparatus according to claim 5, wherein said condition is defined concerning a receiving condition of said reply signal.

7. The authentication apparatus according to claim 5, further comprising a condition setting section for receiving setting of said condition.

8. The authentication apparatus according to claim 1, wherein said storage section stores plural kinds of correspondence relations between said identification information and said first specification information, and wherein priority for displaying the first specification information on said display section is defined for each of the first specification information.

9. The authentication apparatus according to claim 8, wherein said controller is further capable of performing an operation of displaying the first specification information in accordance with said priority when a plurality of external devices are detected.

10. The authentication apparatus according to claim 1, further comprising: a connection section for connecting an external authentication apparatus that stores the first specification information for specifying a user and the second specification information in a manner corresponding to each other and that performs authentication based on said first and said second specification information;
a transmission section for transmitting the first and the second specification information to the external authentication apparatus connected to the connection section; and
a receiving section for receiving an authentication result transmitted from said external authentication apparatus; wherein
said controller is further capable of performing user authentication based on the received authentication result.

11. The authentication apparatus according to claim 1, further comprising a storage section for storing the first specification information that specifies a user and the second specification information in a manner corresponding to each other, wherein
said controller is further capable of performing operations of: determining whether when second specification information is received by said reception section, first specification information corresponding to the received second specification information is stored in said storage section; and
performing user authentication based on the determination result.

12. The authentication apparatus according to claim 1, wherein said controller is further capable of performing operations of: encrypting information to be stored into said storage section; and
decrypting information read from said storage section; and further comprising
a volatile storage section for storing the decrypted information.

13. An authentication apparatus comprising:
display means for displaying first specification information that specifies a user;
reception means for receiving second specification information different from said first specification information;
storage means for storing identification information that identifies an external device and said first specification information in a manner corresponding to each other;
wireless communication means for performing wireless communication with said external device;
detection means for detecting presence or absence of an external device the identification information of which is stored in said storage means, by means of wireless communication;
means for obtaining the identification information from the external device when the detection means detects the presence of said external device;
means for reading first specification information, which is corresponding to the identification information obtained by the above-mentioned means, from said storage means;
means for displaying the read-out first specification information on said display means; and
means for performing user authentication based on the first specification information displayed on said display means and the second specification information received by said reception means.

14. The authentication apparatus according to claim 13, further comprising: means for determining whether said detection means has detected the absence of said external device within a predetermined time after said first specification information is displayed; and
means for bringing said first specification information displayed on said display means into a non-display state, when it is determined that the absence of said external device is detected within said predetermined time after said first specification information is displayed.

15. The authentication apparatus according to claim 13, further comprising: means for determining whether second specification information is received within a predetermined time after said first specification information is displayed; and
means for bringing said first specification information displayed on said display means into a non-display state, when it is determined that the second specification information is not received within said predetermined time.

16. The authentication apparatus according to claim 13, wherein said detection means comprises: means for transmitting a predetermined signal to the outside; and
means for receiving a reply signal returned in response to the transmitted signal;
wherein said detection means detects the presence or absence of said external device based on the received reply signal.

17. The authentication apparatus according to claim 13, further comprising: means for determining whether a predetermined condition is satisfied, when said detection means detects the presence of said external device; and
means for stopping display on said display means when it is determined that said condition is not satisfied.

18. The authentication apparatus according to claim 17, wherein said condition is defined concerning a receiving condition of the reply signal.

19. The authentication apparatus according to claim 17, further comprising means for receiving setting of said condition.

20. The authentication apparatus according to claim 13, wherein said storage means stores plural kinds of correspondence relations between said identification information and said first specification information, and wherein priority for displaying the first specification information on said display means is defined for each of the first specification information.

21. The authentication apparatus according to claim 20, wherein the first specification information is displayed in accordance with said priority when said detection means detects a plurality of external devices are detected.

22. The authentication apparatus according to claim 13, further comprising: means for connecting an external authentication apparatus that stores the first specification information for specifying a user and the second specification information in a manner corresponding to each other and that performs authentication based on said first and said second specification information;
means for transmitting the first and the second specification information to the external authentication apparatus connected to the above-mentioned means;
means for receiving an authentication result transmitted from said external authentication apparatus; and
means for performing user authentication based on the received authentication result.

23. The authentication apparatus according to claim 13, further comprising storage means for storing correspondence between the first specification information that specifies a user and the second specification information;
means for determining whether when second specification information is received by said reception means, first specification information corresponding to the received second specification information is stored in said storage means; and
means for performing user authentication based on the determination result.

24. The authentication apparatus according to claim 13, further comprising: means for encrypting information to be stored into said storage means; and
means for decrypting information read from said storage means; and
means for storing the decrypted information.

25. An image forming apparatus comprising:
a reception section for receiving image data;
an image formation section for forming an image on a sheet based on the received image data; and
an authentication apparatus according to claim 1; wherein
said authentication apparatus performs user authentication when the image data is received.

26. An image forming apparatus comprising:
means for receiving image data;
means for forming an image on a sheet based on the received image data; and
an authentication apparatus according to claim 13; wherein
said authentication apparatus performs user authentication when the image data is received.
